(19) United States
(12) Patent Application Publication
(10) Pub. No.: US 2020/0096111 A1
(43) Pub. Date: Mar. 26, 2020

(54) Anti-Extrusion Device for Pressure Unloading Applications

(71) Applicant: Baker Hughes, a GE company, LLC, Houston, TX (US)

(72) Inventors: James A. Smith, Manvel, TX (US); Andres Sosa, Spring, TX (US)

(73) Assignee: Baker Hughes, a GE company, LLC, Houston, TX (US)

(21) Appl. No.: 16/140,939

(22) Filed: Sep. 25, 2018

(51) Int. Cl. F16J 15/32; E21B 34/06

(52) U.S. Cl. CPC F16J 15/32; E21B 2034/007; E21B 34/06

(57) ABSTRACT

Sealing assemblies for use in creating a fluid seal between two affixed components include a retaining groove and a resilient, compressible sealing element. Rigid back-up members are also disposed within the retaining groove. Interaction of the back-up members with the side surfaces of the retaining groove help to retain the sealing element and back-up members within the retaining groove and prevent extrusion of the sealing element.

### BACKGROUND OF THE INVENTION

### 1. Field of the Invention

The invention relates generally to fluid sealing assemblies.

### 2. Description of the Related Art

Fluid seals are widely used to help prevent fluid leaks in association with piping and related components. Typical fluid seals incorporate a resilient, compressible O-ring and may reside in an annular retaining groove. Fluid seals of this type are often used with sliding sleeve valves to preclude leakage when the sleeve valve is closed. When seals are used in applications where high fluid pressures are present (i.e., piping containing high pressure fluid), the O-ring seals can be unseated from their retaining grooves or even damaged when the seal is unloaded. An example of such a situation is a sliding sleeve valve which, when opened, releases pressurized fluid. Sliding sleeve devices of this type are often used in downhole, hydrocarbon production situations wherein high temperatures and pressures can cause such seals to extrude out of their retaining grooves.

### SUMMARY OF THE INVENTION

The invention provides sealing assemblies which include an annular resilient and compressible sealing member. In described embodiments, the sealing member may be an elastomeric O-ring. Described sealing assemblies also include a retaining groove within which the sealing member is disposed. In a first described embodiment, the retaining groove has a dovetail cross-sectional shape wherein the interior surface, or base, of the groove is wider than the opening of the groove. According to a second described embodiment, the base of the groove is essentially the same width as the opening of the groove. In this embodiment, the side surfaces of the groove have a V-shape or other shape designed to prevent backup members from exiting the retaining groove.

Backup members are disposed within the groove adjacent the sealing member. Preferably, the one or more backup members are shaped to contact at least one side surface of the groove so that the backup members are retained within the groove when lateral force is applied to the backup members. Each of the backup members presents a groove-contacting side surface which is shaped to be generally complementary to the side surface it adjoins. The backup members become interlocked with the side surfaces when the sealing assembly is loaded or energized.

Preferably also, the back-up members each have a sealing element contacting surface which contacts the sealing element and help to retain it within the groove. Preferably, the sealing element contacting surface is concave or V-shaped to allow portions of the sealing element to expand into when it is compressed.

A sealing element capture gap is defined between the two back-up members. In particular, the sealing element capture gap is defined between the upper portions of the back-up elements which would engage the sealing element to prevent it from exiting the retaining groove. This gap becomes smaller when the sealing assembly is unloaded or de-energized.

The sealing member and backup members are retained within the retaining groove and extrusion of the sealing element from the retaining groove is prevented by the backup members and the configuration of the retaining groove. This is advantageous during high pressure unloading where the seal will be exposed to forces which would tend to unseat it or damage it. Further, the configuration of the backup members will tend to prevent extrusion of the sealing element from the retaining groove over time.

### BRIEF DESCRIPTION OF THE DRAWINGS

For a thorough understanding of the present invention, reference is made to the following detailed description of the preferred embodiments, taken in conjunction with the accompanying drawings, wherein like reference numerals designate like or similar elements throughout the several figures of the drawings and wherein:

FIG. 1 is a side view of an exemplary sliding sleeve valve device which incorporates sealing assemblies in accordance with the present invention.

FIG. 2 is a side, cross-sectional view of an exemplary sealing assembly constructed in accordance with the present invention.

FIG. 3 is a side, cross-sectional view of the sealing assembly of FIG. 1, now in a pressure loaded condition.

FIG. 4 is a side, cross-sectional view of an alternative sealing assembly in accordance with the present invention.

FIG. 5 is a side, cross-sectional view of the sealing assembly of FIG. 4, now in a pressure loaded condition.

### DETAILED DESCRIPTION OF THE PREFERRED EMBODIMENTS

Sealing assemblies constructed in accordance with the present invention can be incorporated into one of two components to be assembled together and provide a fluid seal when so assembled. A sealing assembly in accordance with the present invention can be incorporated into a sliding sleeve assembly.

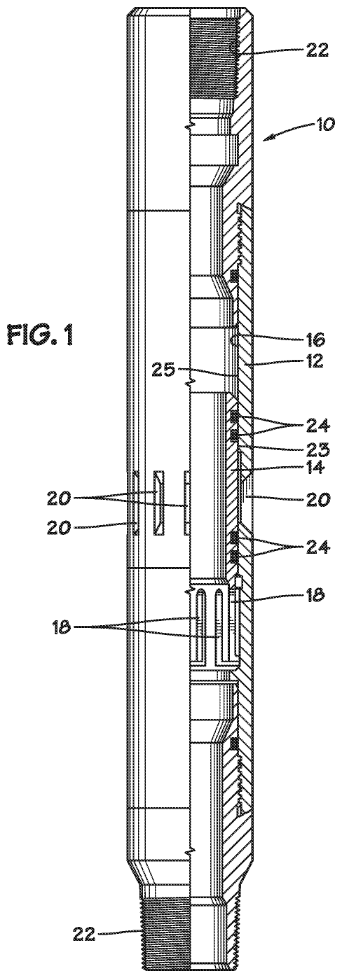

FIG. 1 illustrates an exemplary sliding sleeve valve device 10 which includes an outer mandrel 12 and an inner sleeve 14. The mandrel 12 defines a central axial flowbore 16 along its length. The sleeve 14 resides within the flowbore 16 and is axially slidable therewithin with respect to the mandrel 12. The sleeve 14 presents a detent collet 18 which helps the sleeve 14 stay in either an open or closed positions, as is known in the art. A set of outer radial ports 20 are disposed through the mandrel 12. The mandrel 12 further provides threaded end connections 22 so that the sliding sleeve valve 10 can be incorporated into a tubing string for use in a well bore environment. Seal assemblies 24, in accordance with the present invention, are incorporated into the sleeve 14. As those of skill in the art understand, the sleeve 14 is axially moveable between a closed position (illustrated in FIG. 1) wherein the sleeve 14 straddles and blocks fluid flow through the outer ports 20, and an open position wherein the outer ports 20 are not blocked so that fluid may pass through. It should be noted that the depicted sliding sleeve valve 10 is presented only as an example to show one possible use of the sealing assembly of the present invention and is not intended to limit the use of the claimed sealing assemblies to the depicted application.

The sleeve 14 presents a radially outwardly-facing first sealing surface 23, while the mandrel 12 presents a radially inward-facing second sealing surface 25. A sealing assembly 24, in accordance with the present invention, is incorporated into the first sealing surface 23. The sealing assembly 24 will be energized to create fluid sealing when the first sealing surface 20 abut the second sealing surface 25 when the two components 12, 14 are assembled. During operation of the sleeve valve 10, the sealing assemblies 24 will go through various stages of being loaded (i.e., sealing assembly compressed) and unloaded. For example, portions of the sealing assemblies 24 are unloaded as they are moved across an outer radial port 20.

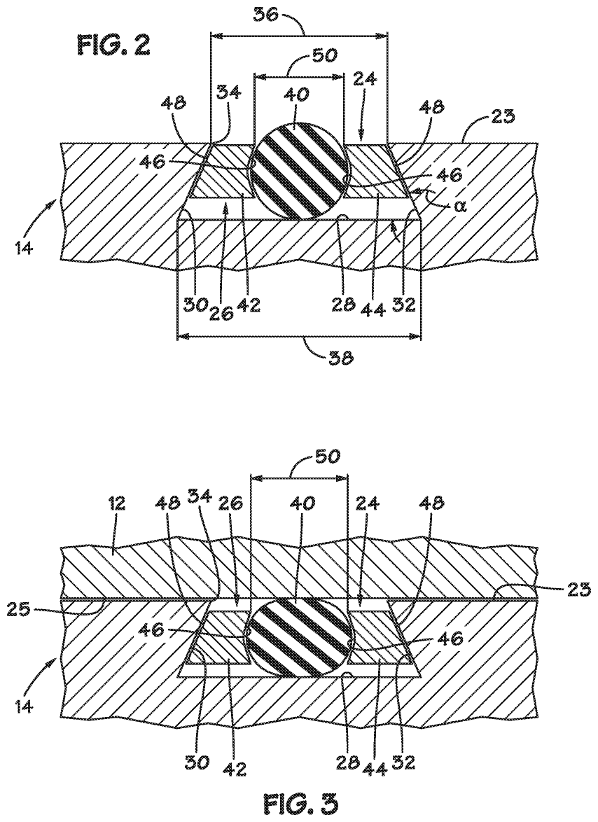

FIGS. 2 and 3 illustrate an exemplary sealing assembly 24, constructed in accordance with the present invention, in greater detail. The sealing assembly 24 includes an annular retaining groove 26. The retaining groove 26 has an interior surface, or base, 28. Side surfaces 30 and 32 extend upwardly from the base 28 to a groove opening 34. In the depicted embodiment, the side surfaces 30, 32 are oriented at an acute angle (α) with respect to the base 28 such that the opening 34 has a width 36 that is less than the width 38 of the base 28. The side surfaces 30, 32 may be planar or curved.

An annular sealing member 40 resides within the retaining groove 26. The sealing member 40 is preferably compressible and resilient. In the depicted embodiment, the sealing member 40 is an elastomeric O-ring. The sealing member 40 is sized such that a portion of the sealing member 40 extends outwardly beyond the opening 34 of the retaining groove 26 when the sealing member 40 is disposed within the retaining groove 26.

At least one backup member is also disposed within the retaining groove 26. In the depicted embodiment, there are two backup members, first backup member 42 and second backup member 44. Each of the back-up members 42, 44 is positioned between the sealing member 40 and one of the side surfaces 30 or 32. In preferred embodiments, the back-up members 42, 44 are substantially rigid and may be formed of metal, ceramic, rigid plastics and the like. It is further preferred that each of the backup members 42, 44 have a split ring or C-ring configuration so that the backup members 42, 44 may be radially expanded and contracted within the groove 26. A split ring configuration will also assist in assembly and repair of the sealing assembly 24.

Each of the backup members 42, 44 presents a sealing element contact surface 46 which will adjoin or be in contact with the sealing element 40 when the sealing assembly 24 is assembled. The sealing element contact surface 46 is intended to largely capture a portion of the sealing element 40 to prevent extrusion of or escape of the sealing element 40 out of the retaining groove 26 during operation. When the sealing assembly 24 is energized to create a seal, the sealing element 40 can expand into the sealing element contact surface 46. In particular preferred embodiments, the sealing element contact surface 46 is concave or substantially V-shaped.

Each of the backup members 42, 44 also presents a groove-contacting side surface 48 which will adjoin and contact one of the side surfaces 30 or 32 during operation. Preferably, the groove-contacting side surfaces 48 are substantially smooth to facilitate their ability to slide upon the respective side surface 30 or 32 it is brought into contact with. In the depicted embodiment, a sealing element capture gap 50 is defined between the upper ends of the back-up members 42, 44.

In operation, the sealing assembly 24 is in the initial, unloaded condition which is illustrated by FIG. 2. The sealing element 40 is lightly in contact with the sealing member contact surfaces 46 of each of the backup members 42, 44. The backup members 42, 44 may be lightly in contact with the side surfaces 30, 32 of the retaining groove 26. As the sealing element 40 is compressed, it also expands toward each of the side surfaces 30 and 32. In the case of the sliding sleeve valve 10, movement of the sliding sleeve 14 to an open position could cause pressurized fluid to move over the sealing assembly 24 and typically attempt to lift the sealing element 40 out of its groove 28. Orienting the side surface 30, 32 at acute angles with the base 28 ensures that, when opening the sleeve 14 with a differential, both the sealing element 40 and the backup members 42, 44 are lifted toward the opening 34 of the retaining groove 26. The further these elements move out of the retaining groove 26, the more the backup members 42, 44 will squeeze the sealing element 40 and trap all three elements within the retaining groove 26. As a result, the back-up members 42, 44 become interlocked with the side surfaces 30, 32 of the retaining groove 26. The sealing element capture gap 50 would become larger when the sealing assembly 24 is in a loaded condition, unless frictional forces between backup members 42, 44 and the side surfaces 30, 32 exceed the downward force of the pressure acting upon the backup members 42, 44. Fluid sealing is established between the sealing element 40 and the second sealing surface 22, as depicted in FIG. 3.

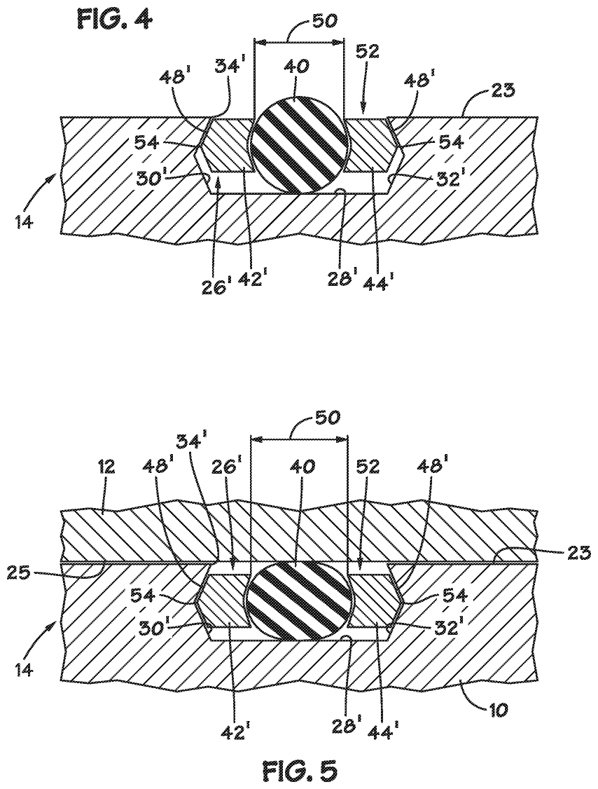

FIGS. 4-5 illustrate an alternative sealing assembly 52 which is similar in many respects to the sealing assembly 24 described above. However, the retaining groove and backup members are shaped differently. The retaining groove 26′ features a base 28′ which is essentially the same width as the width of the opening 34′. In the depicted embodiment, the side surfaces 30′, 32′ are V-shaped. The side surfaces 30′, 32′ may have other shapes which provide a portion that is recessed away from both the base 28′ and the opening 34′. For example, the side surfaces 30′, 32′ may be U-shaped or rounded.

The backup members 42′ and 44′ each present a groove contacting side surface 48′ which is shaped to be generally complementary to the side surface 30′ or 32′ which it adjoins. In this instance, the groove contacting side surfaces 48′ are pointed having a point or apex 54. Should the side surfaces 30′, 32′ have other shapes (such as U-shaped or rounded), the groove contacting side surfaces 48′ will likewise, be shaped in a manner which is complementary to them.

Operation of the sealing assembly 52 is similar to operation of the sealing assembly 24 described earlier. As the sealing member 40 is compressed, it expands toward each of the side surfaces 30′, 32′. The point or apex 54 of each of the back-up members 42′; and 44′ will be slid into the recess formed by the V-shape of the side surfaces 30′, 32′. When unloading the sealing assembly 52, both the sealing element 40 and the back-up members 42′ and 44′ are lifted toward the opening 34′ of the retaining groove 26′. The further these elements move out of the retaining groove 26′, the more the back-up members 42′ and 44′ will squeeze the sealing element 40 and trap all three elements within the retaining groove 26′. As a result, the back-up members 42′, 44′ become interlocked with the side surfaces 30′, 32′ of the retaining groove 26′. It is further noted that the backup members 42′ and 44′ also define a sealing element capture gap 50 which becomes larger when the sealing assembly 52 is in a loaded condition and smaller when the sealing assembly 52 is unloaded.

What is claimed is:

1. A sealing assembly for forming a fluid seal between a first component and a second component, the sealing assembly comprising:
an annular retaining groove formed within the first component, the retaining groove having a base, an opening and two side surfaces which extend from the base to the opening;
an annular resilient, compressible sealing member disposed within the retaining groove;
a rigid first backup member disposed within the retaining groove, the backup member presenting a groove contacting side surface and a sealing element contact surface.

2. The sealing assembly of claim 1 wherein:
the base of the groove is wider than the opening of the groove; and
the side surfaces form an acute angle with the base.

3. The sealing assembly of claim 1 wherein:
the side surfaces are shaped to form a recess into which a portion of the backup member will enter when the sealing assembly is loaded; and
the groove-contacting side surface of the first backup member presents a portion which enters the recess when the sealing assembly is loaded to lock the backup member within the retaining groove.

4. The sealing assembly of claim 3 wherein:
the recess is V-shaped; and
the portion of the groove-contacting side surface is pointed.

5. The sealing assembly of claim 1 further comprising:
a second back-up member disposed within the retaining groove;
the sealing member is located between the first and second backup members within the retaining groove;
a sealing member capture gap is defined between the first and second backup members; and
the sealing member capture gap is smaller when the sealing assembly is unloaded.

6. A sealing assembly for forming a fluid seal between a mandrel and a sleeve within a sliding sleeve valve, the sealing assembly comprising:
an annular retaining groove formed within the first component, the retaining groove having a base, an opening and two side surfaces which extend from the base to the opening;
an annular O-ring sealing member disposed within the retaining groove;
a rigid first backup member disposed within the retaining groove, the backup member presenting a groove contacting side surface and a sealing element contact surface.

7. The sealing assembly of claim 6 wherein:
the base of the groove is wider than the opening of the groove; and
the side surfaces form an acute angle with the base.

8. The sealing assembly of claim 1 wherein:
the side surfaces are shaped to form a recess into which a portion of the backup member will enter when the sealing assembly is loaded; and
the groove-contacting side surface of the first backup member presents a portion which enters the recess when the sealing assembly is loaded to lock the backup member within the retaining groove.

9. The sealing assembly of claim 8 wherein:
the recess is V-shaped; and
the portion of the groove-contacting side surface is pointed.

10. The sealing assembly of claim 6 further comprising:
a second back-up member disposed within the retaining groove;
the sealing member is located between the first and second backup members within the retaining groove;
a sealing member capture gap is defined between the first and second backup members; and
the sealing member capture gap is smaller when the sealing assembly is unloaded.

11. A sealing assembly for forming a fluid seal between a first component and a second component, the sealing assembly comprising:
an annular retaining groove formed within the first component, the retaining groove having a base, an opening and two side surfaces which extend from the base to the opening;
an annular resilient, compressible sealing member disposed within the retaining groove;
first and second backup members disposed within the retaining groove, each of the first and second backup members being disposed between the sealing element and a side surface of the retaining groove, the back-up member presenting a groove-contacting side surface and a sealing element contact surface.

12. The sealing assembly of claim 11 wherein:
the base of the groove is wider than the opening of the groove; and
the side surfaces form an acute angle with the base.

13. The sealing assembly of claim 11 wherein:
the side surfaces are shaped to form a recess into which a portion of the back-up member will enter when the sealing assembly is loaded; and
the groove-contacting side surface of the first backup member presents a portion which enters the recess when the sealing assembly is loaded to lock the backup member within the retaining groove.

14. The sealing assembly of claim 13 wherein:
the recess is V-shaped; and
the portion of the groove-contacting side surface is pointed.
